(19) United States
(12) Patent Application Publication
(10) Pub. No.: US 2014/0129407 A1
(43) Pub. Date: May 8, 2014

(54) Order Fulfillment Method And System

(71) Applicant: GOLDMAN, SACHS & CO., New York, NY (US)

(72) Inventors: Christopher White, New York, NY (US); Justin Gmelich, New York, NY (US); Dimiter Georgiev, New York, NY (US); Debra Herschmann, New York, NY (US); Paul J. Huchro, New York, NY (US); Wichar Jiempreecha, New York, NY (US); Ross Levinsky, New York, NY (US); Johnny Shaffer, New York, NY (US); Stephanie Miriam Sklar, New York, NY (US); Paul Walker, New York, NY (US)

(73) Assignee: GOLDMAN, SACHS & CO., New York, NY (US)

(21) Appl. No.: 13/671,555

(22) Filed: Nov. 7, 2012

(51) Int. Cl. G06Q 40/04

(52) U.S. Cl. 705/37

(57) ABSTRACT

A method and system for filling orders based on time of order entry and liquidity allocation are disclosed. A trading system having an order fulfillment engine, receives orders to trade a financial instrument. Each order may specify an order size and a trade side. The system identifies a trade side with aggregate order size larger than that of an opposing trade side and determines a priority for executing orders on the identified trade side based on available liquidity and time of order entry. The one or more orders on the identified trade side are then executed according to the determined priority.

### BACKGROUND

Electronic trading is a method of trading financial instruments such as stocks, bonds, foreign exchange and financial derivatives electronically. Buyers and sellers use electronic trading platforms, such as those provided by investment banks, to submit buy (bid) orders and sell (offer) orders for a tradable financial instrument to an exchange. The exchange utilizes order matching algorithms to match the buy orders with the sell orders. Order matching algorithms typically utilized by an exchange include first in, first out (FIFO) algorithms and pro rata algorithms. FIFO algorithms execute orders in the sequence in which they are entered in the order book, that is, they are executed according to time priority. Pro rata algorithms, on the other hand, fill orders according to allocations determined based on the best bid/offer in the market, the time the order was entered and volume of the order. Pro rata algorithms reward the order size over the time of order entry.

### BRIEF DESCRIPTION OF THE DRAWINGS

FIG. 1 is diagram illustrating an example environment within which an electronic trading server may operate.

FIG. 2 is a block diagram illustrating the electronic trading system.

FIG. 3 is a logic flow diagram illustrating order fulfillment method.

FIGS. 4A-E are graphical user interface diagrams for order entry and processing.

FIG. 4F is a graphical user interface diagram illustrating an order fulfillment report.

FIGS. 5A-B are user interface diagrams illustrating order books before and after order fulfillment.

FIG. 6 is a block diagram of the trading server controller.

### DETAILED DESCRIPTION

Order fulfillment method and system described herein facilitate trading of financial instruments using an algorithm that seeks to equally reward time and size of client orders. Clients may utilize electronic trading platforms to place orders for financial products over a network with brokers, market makers, investment banks or exchanges (hereinafter “financial intermediary”). Electronic trading platforms may include proprietary trading platforms, and include software using which clients or traders may trade various financial instruments including, but not limited to: securities, cash, derivatives, over the counter (OTC) products, and the like. Securities include debt securities (e.g., bank notes, bonds, debentures, and the like), equity securities (e.g., stocks) and derivatives (e.g., futures, options, forwards, swaps, and the like.). Clients may use trading accounts such as corporate bond trading accounts to access the trading platform and place orders for desired financial instruments. The trading server may include an order fulfillment engine that receives and fills orders based on time of order entry according to liquidity allocation.

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

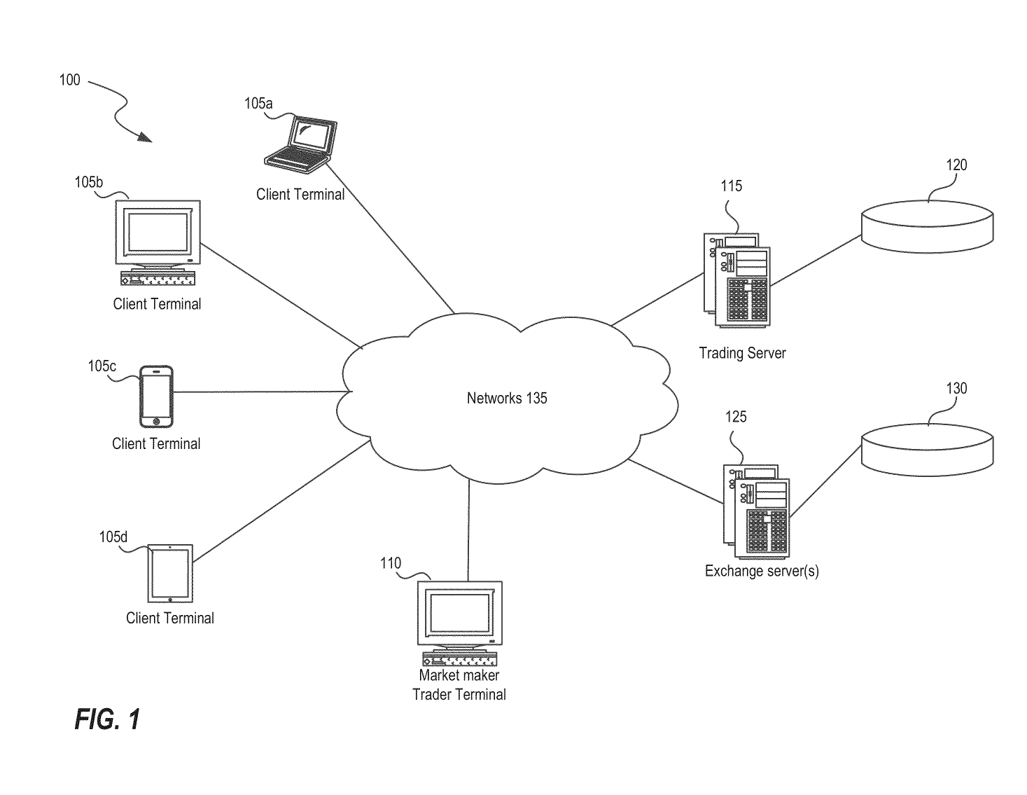

FIG. 1 is diagram illustrating an example environment within which an electronic trading server may operate. Environment 100 may include a plurality of client terminals using which clients or traders working on behalf of clients, may enter trade orders. In one implementation, clients may include investors. In a further implementation, such investors may be Qualified Institutional Buyers (QIBs). Non-limiting examples of client terminals include, but are not limited to: a laptop computer 105a, a desktop computer 105b, a mobile device 105c, a tablet device 105d, and/or the like. Clients may utilize any of the client terminals to access the electronic trading platform with which they have an account. The electronic trading platform may be supported by trading server 115, or another server operated by or controlled by the trading server. Such server may perform authentication of client credentials at login and encrypt/decrypt communication in compliance with the requirements of regulatory agencies. Trading server 115 includes the order fulfillment engine and other modules for receiving trade orders, allocating available liquidity, determining priority for executing trade orders, providing a report on the executions, and/or the like. Trading server 115 may be coupled to one or more databases and/or tables represented by database 120. The environment 100 may also include one or more trader terminals, represented by terminal 110. Trader terminal 110 may be utilized by a trader, working on behalf of the financial intermediary of the electronic trading platform, to oversee trade executions, inject additional liquidity to reduce order imbalances, and the like.

As previously discussed, various financial products may be traded via the electronic trading platform. For example, in one implementation, the electronic trading platform may be used for trading bonds. Various types of bonds may be traded. For example, bonds include, but are not limited to: corporate bonds, mortgage-backed or asset-backed securities, international bonds (e.g., Eurodollar bond), high yield bonds, convertible bonds, exchangeable bonds, and/or the like. In a bond trading platform, bond investors such as financial institutions, pension funds, mutual funds and governments may utilize any of the client terminals 105a-d to trade large blocks of bonds with bond dealers and/or brokers. The bond trading platform server may utilize the order fulfillment engine and other modules to facilitate trading of bonds. As bonds are usually traded in the over-the-counter market, rather than an exchange market, majority of bonds may be traded using the bond trading platform. Some corporate bonds, and certain bond futures and/or options may be listed in an exchange. Similarly, other financial products such as stocks, options, commodities, futures, and the like, are typically traded through an exchange. As such, in some embodiments, the order fulfillment engine may be embodied in an exchange server 125. The exchange server may be coupled to one or more databases and/or tables 130. In one embodiment, functions of servers 115 and 125 may be consolidated into one. The term “trading server” generally refers to a server embodying the order fulfillment engine described in this application.

Although not shown, environment 100 may include trade reporting entities or exchanges with which the trading server may be in communication with. For example, the trading server may connect to or communicate with the Depository Trust and Clearing Corporation (DTCC) for clearance and settlement of executed trades, and/or an exchange such as NASDAQ for posting trades. Client terminals 105a-d, trader terminal 110, trading server 115 and/or exchange server 125 may connect to and communicate with each other across network 135 using secure communications protocols such as File Transfer Protocol (FTP), HyperText Transfer Protocol (HTTP), Secure HyperText Transfer Protocol (HTTP(s)), Secure Socket Layer (SSL), and/or the like. Examples of network 135 may include private networks and public networks (e.g., the Internet). The term “server” as used throughout this application refers generally to a computer, device, program, or combination thereof that processes and responds to requests from remote client devices operated by users across a network. The term “client” generally refers to a computer, program, device, user and/or combination thereof that processes and sends requests and receives and processes responses from remote servers across a network.

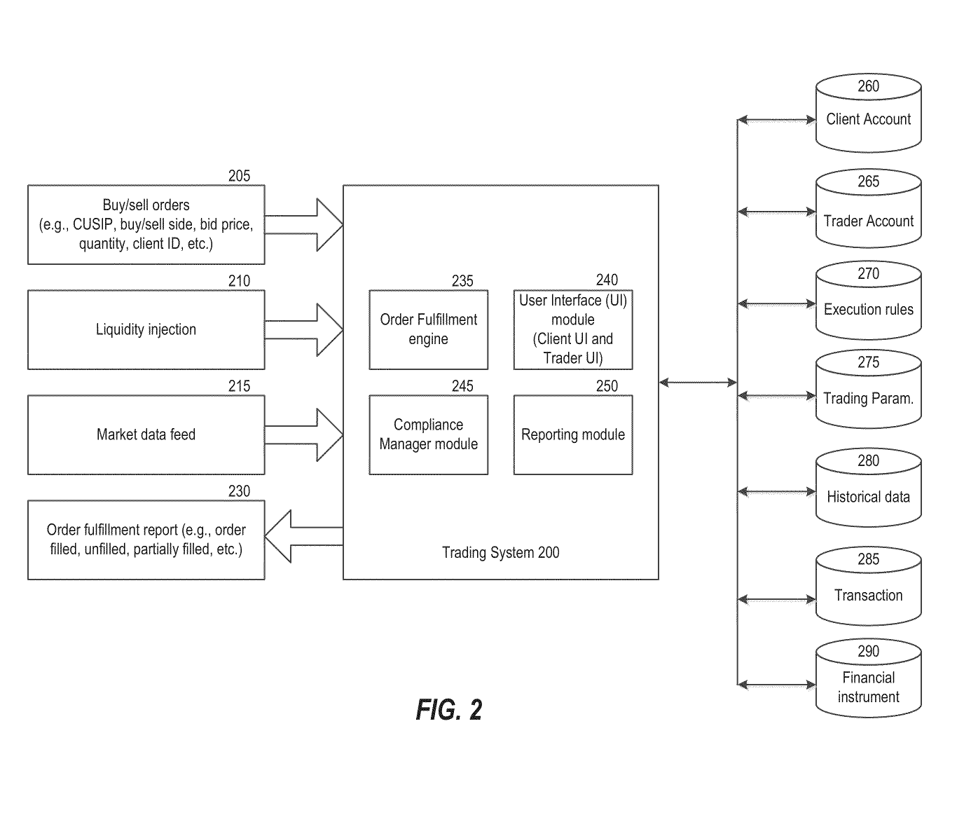

FIG. 2 is a block diagram illustrating the electronic trading system. Trading system 200 may include one or more inputs 205-215, one or more modules 235-250, one or more database tables 260-290, and one or more outputs 230 generated from the processing of the inputs and data retrieved from the database tables by the modules. In one embodiment, trading system 200 includes at least one buy or sell order 205 to buy or sell a financial instrument. The order may be input by a client via a trading platform graphical user interface accessed from a client terminal. A trader working on behalf of the client may also utilize the trading platform to enter orders. The buy/sell order may include information such as, but not limited to: a financial instrument identifier (e.g., CUSIP number), identification of a buy or sell side, bid/ask price, quantity, client/trader identifier, and/or the like. The buy/sell order may be considered a limit order as it specifies the price. The specified price may be defined by a trader creating the two-sided market, for example. In one implementation, liquidity injection 210 may be provided to the trading platform as an input to reduce any trade imbalance. The liquidity injection 210 defines a notional amount of liquidity that the trading system makes available for execution. The trading server may also receive as input market data feed 215. The market data feed may include information such as price and size data for options traded on exchanges, bond quotes, Trade Reporting and Compliance Engine (TRACE) data, and/or the like. Such data may be in the form of macro data aggregated by various entities such as the Financial Industry Regulatory Authority (FINRA) and other data feed providers, and offered to subscribing clients, members or the general public. Other data feeds may also be connected to the trading system 200.

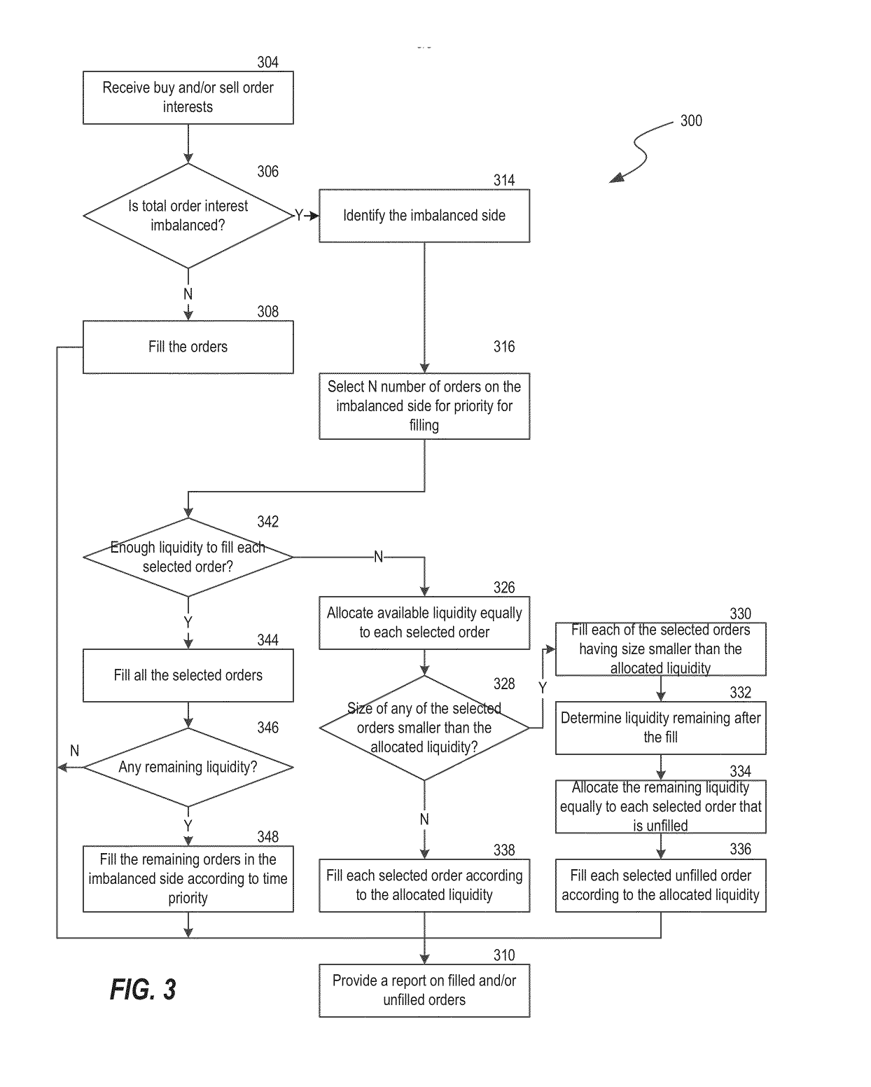

Trading system 200 may include order fulfillment engine 235, user interface (UI) module 240, compliance manager module 245, and reporting module 250, among others. The order fulfillment engine and other modules may be in the form of software, program code or algorithm stored in the memory, which when executed facilitate order fulfillment. Order fulfillment engine 235 uses buy/sell order input 205, liquidity injection 210, and/or market data feed 215 to execute one or more orders according to a priority determined using order execution rules. The process of determining the priority for execution and executing orders based on the priority are discussed in detail with respect to FIG. 3. UI module 240, which includes client and/or trader Uls, provides trading platform user interfaces for login, entering and submitting orders, viewing order books, reports, historical data, streaming live market prices, charting options, news feed, account management tools, and/or the like. Compliance module 245 may include facilities for monitoring and managing compliance procedures. For example, all brokers/dealers who are FINRA member firms have to comply with an obligation to report transactions in corporate bonds to TRACE. Reporting module 250 may generate and/or transmit reports on order executions to the clients/traders, and/or other reporting entities such as other exchanges, DTCC, FINRA, and/or the like. The client reports may include information on the notional trade volume, information on any unfilled orders, filled orders, price and spread, and/or the like.

One or more database components may connect to and/or communicate with the various modules of the trading system 200. Client account database table 260, may include various data fields such as, but not limited to: a client name, a client identifier, login credentials, funding information, an account type, an address, and the like. Trader account database table 265 may include data fields such as, but not limited to: a trader name, a trader identifier, login credentials, client identifiers, and the like. Execution rules database table 270 may include data fields such as, but not limited to: a rule identifier, conditions, outcomes, number of orders to be prioritized (N), and the like. Trading parameters database table 275 may include fields such as, but not limited to: a security identifier, a bid, an ask, a minimum order size, an increment size, a coupon, a maturity, a price, a yield, a bid-ask spread, and/or the like. Historical data database table 280 may include fields such as, but not limited to: a security identifier, TRACE data such as execution size, price, change in price over a day, change in price over a week, change in price over a month, yield, trade type, execution time, and/or the like. Transaction database table 285 may include fields such as, but not limited to: an order identifier, a transaction identifier, a security identifier, a security description, a trade side, an order size (or trade volume), a bid/ask, a total trade volume, an execution price, and/or the like. Financial instrument database table 290 may include fields such as, but not limited to: a financial instrument identifier, a name, a category, a type, a class, a sub-class, a current price, a price source, and/or the like.

The modules of the trading system 200 may connect to and/or communicate with each other, and may access data from and/or store data into the database tables. For example, the order fulfillment engine receives and/or obtains buy/sell orders, liquidity injection and/or market data feed from the user interface module and uses the data to determine and execute orders. In one implementation, the order fulfillment engine and/or the user interface module may provide and/or check with the compliance manager module prior to, and in some cases, after executing trades. In another implementation, the order fulfillment engine may provide results from executions to the reporting module and user interface module to inform the clients of executions (full or partial) and non-executions, for clearing and settlement, and the like. Furthermore, in some implementations, the modules may also store received orders, trade parameters, transaction data, and/or the like in appropriate database tables 260-290. It should be noted that in some implementations, one or more of these modules may be consolidated into a single module. In some instances, implementation of one or more of these modules may be made optional.

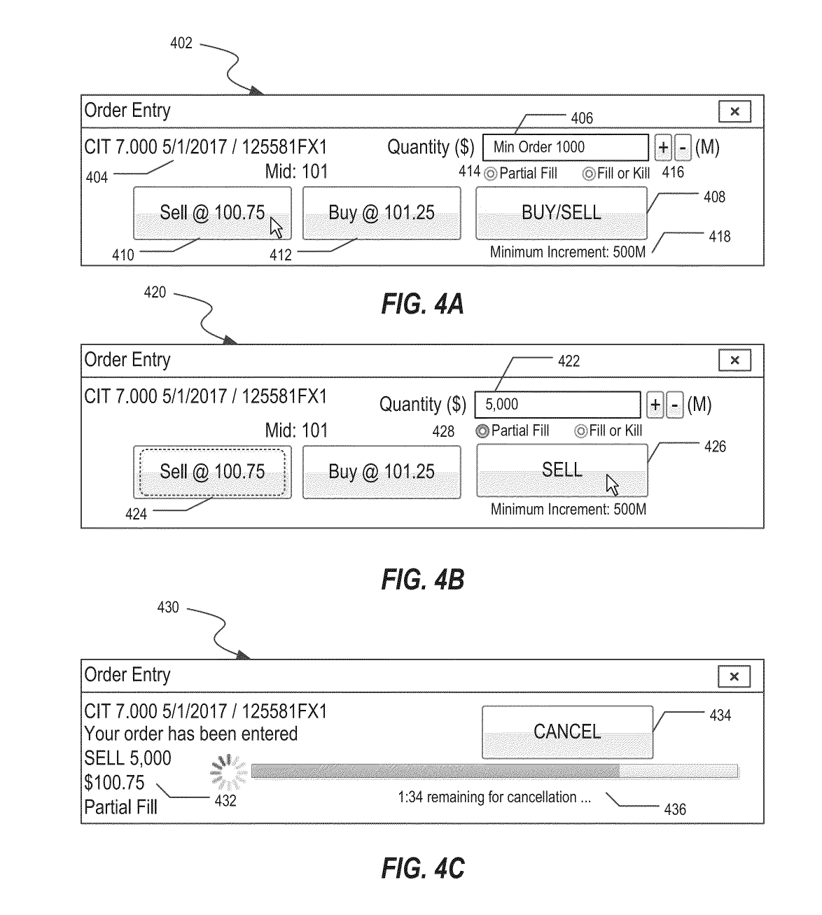

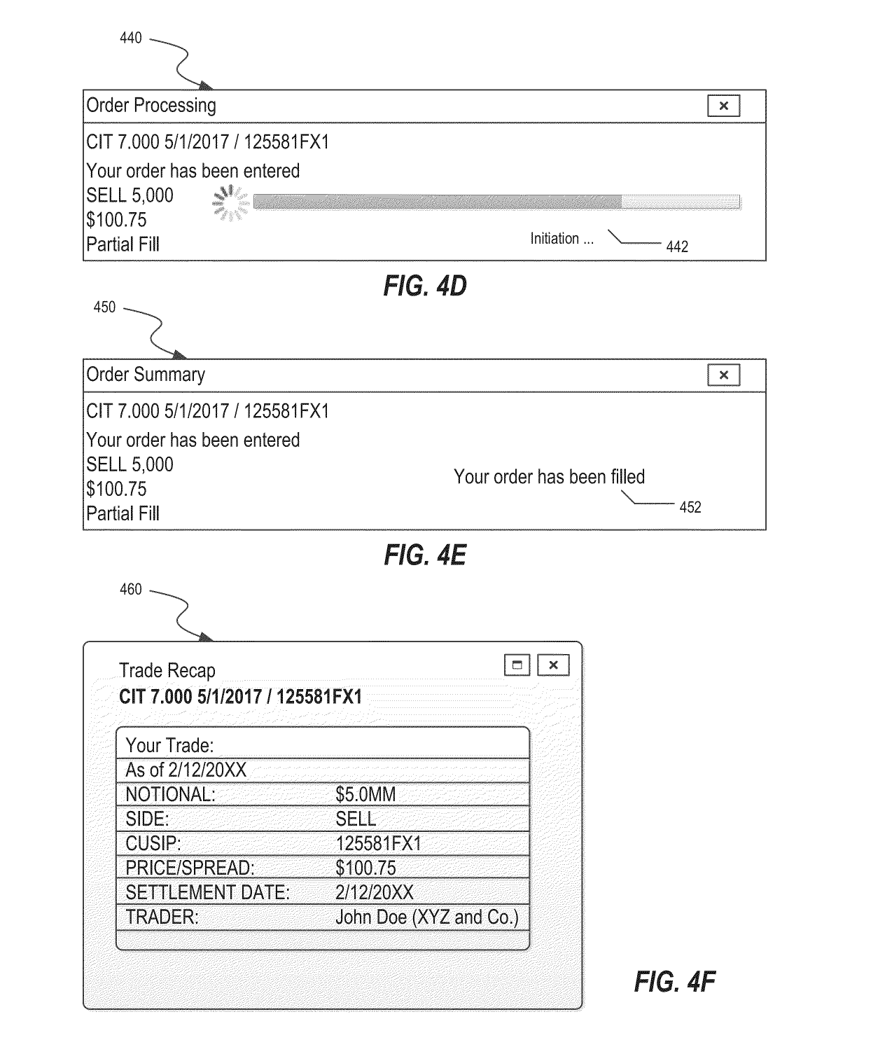

FIG. 3 is a logic flow diagram illustrating an order fulfillment method implemented by the trading system. Order fulfillment method 300 may be applicable to, and adapted for various electronic trading systems including session based trading systems, where the trading platform offers trading at a specified time for limited periods for an individual security or a group of securities and/or any other trading systems using an allocation methodology. Order fulfillment method 300 may be initiated when clients submit orders using the trading platform user interface. The submissions may be received by the trading system at block 304. In one implementation, a client order may be referred to as an order interest as the trading system may allow the client a predefined amount of time (e.g., two minutes) during which the client may cancel the order. The trading platform user interfaces for client order entry may include the user interfaces shown in FIGS. 4A and 4B. An order interest may include information such as, but not limited to: a security identifier, a desired trade or execution side, a price, a quantity, an execution type and/or the like. The submitted buy and/or sell orders creates a two-sided market. At decision block 306, the order fulfillment engine determines if the buy and sell order interests are imbalanced. The imbalance is created when the total buy interest and the total sell interest do not match. For example, if there is $30 MM in sell interest and $20 MM in buy interest, the sell interest and the buy interest do not match, and thus create an imbalance. The imbalanced side of a two-sided market is the larger side of the total order interests for a given session or at a point of time. In this example, the imbalanced side is the sell side with $30 MM in sell interest.

When the buy interest and the sell interest match or are balanced, the order fulfillment engine fills the buy/sell orders at block 308. In one embodiment, the order fulfillment engine fills the buy/sell orders by executing trades where the trading system or trading system dealer is the principal. For example, the trading system may receive two $5 MM buy orders from clients A and B respectively, and a $10 MM sell order from client C. The trading system allows the trader to take the risk and purchase the securities in the amount of $10 MM from client C, thereby filling the sell order. The trading system allows the trader to use its inventory to sell securities in the amount of $5 MM to both clients A and B, thereby filling the buy orders. In an alternate embodiment, the order fulfillment engine may fill the buy/sell orders by crossing the orders. When the order fulfillment engine uses cross trade to fill the orders, the trading system transfers or swaps out securities from one client account to another. A report on the filled orders is then provided to the respective clients at block 310.

When the total order interests are imbalanced, the order fulfillment engine identifies the imbalanced side at block 314. The identification may be based on comparing the total sell interest and total buy interest as described above. The order fulfillment engine is configured to determine the total number of orders (N) that must be filled on the imbalanced side before other orders can be filled. In one implementation, the N orders are selected based on time priority. N may be any number provided as an input parameter to or specified as a default parameter in the order fulfillment engine. For example, in one implementation, N may be equivalent to 5. At block 316, the order fulfillment engine selects the first N orders on the imbalanced side as having the first priority for filling. In one implementation, when the total number of interests on the imbalanced side is less than N, all of such orders may be selected as having the first priority for filling.

At decision block 342, the order fulfillment engine determines if there is enough liquidity to fill each of the selected orders. The available liquidity may be the notional value available for execution, which in some implementations, may be supplemented by liquidity injected by a trader overseeing the trade. For example, the trading system receives $100 MM in buy interest and $50 MM in sell interest, and provides $50 MM in liquidity. Since the buy interest is the larger of the two sides, the buy side is the imbalanced side. If the first five buy orders are each $5 MM, then the available liquidity of $50 MM is sufficient to fill each of the first five buy orders, with $25 MM liquidity remaining. If the order fulfillment engine determines that there is enough liquidity to fill the first N orders, the order fulfillment engine fills those orders at block 344. As previously discussed, the order fulfillment engine can fill the orders executing the orders against the principal or by crossing the orders. After filling the first N orders, the order fulfillment engine further determines if there is any remaining liquidity to fill any of the orders behind the first N orders on the imbalanced side at block 346. If there is no liquidity remaining, no more orders will be fulfilled. The order fulfillment engine then concludes the order fulfillment process by providing a report on the executions and/or non-executions to the respective clients at block 310. A trade execution report may be similar to the trade recap graphical user interface illustrated in FIG. 4F.

If, on the other hand, there is liquidity remaining, the orders remaining on the imbalanced side may be filled according to time priority at block 348. Referring to the above example, after filling the first five buy orders, each of which is $5 MM, the liquidity remaining is $25 MM. If the sixth order is $10 MM and the seventh order is $20 MM, the order fulfillment engine fills the sixth order first, and uses the remaining liquidity of $15 MM to partially fill the seventh order. After filling as many remaining orders as possible with the available liquidity and according to time priority, the order fulfillment engine generates a report summarizing the executions and/or non-executions at block 310.

Referring back to the decision block 342, if there is not enough liquidity to fill each of the selected orders, the method moves to block 326. At 326, the order fulfillment engine allocates the available liquidity equally to each selected order. For example, if the available liquidity is $50 MM, and there are five selected orders, each order, regardless of the size, is initially allocated liquidity equal to $10 MM. At block 328, the order fulfillment engine determines if the size of any of the selected orders is smaller than the allocated liquidity. If so, the order fulfillment engine may, first and foremost, fill each of the selected orders having size smaller than the allocated liquidity at block 330. At block 332, the liquidity remaining after filling the orders at block 330 may be determined. At block 334, the remaining liquidity may be allocated equally to each selected order that is unfilled. At block 336, the selected unfilled orders may be filled according to the allocated liquidity. Conversely, at decision block 328, if the size of any of the selected orders is larger than or equal to the allocated liquidity, each selected order may be filled according to the allocated liquidity at block 338. After completing the process at blocks 338 or 336, the order fulfillment engine provides a report on the executions and/or non-executions to the respective clients at block 310.

Several examples provided below further illustrate the liquidity allocation and order fulfillment method utilized by the order fulfillment engine. In each of the following examples, there is $100 MM buy interest (imbalanced side) and $50 MM sell interest (available liquidity).

Example 1: if the first five buy orders are each $5 MM, each of the orders are filled, and subsequent orders are filled with the remaining available liquidity ($25 MM) based on time priority.

Example 2: if the first five buy orders are each $15 MM, each order receives a $10 MM allocation, determined by dividing the availability liquidity by the number of selected orders on the imbalanced side ($50 MM/5). There is no remaining liquidity available for subsequent orders.

Example 3: if one of the first five orders is for $6 MM and the remaining four are for $15 MM each, the $6 MM order receives a full fill of $6 MM, while the remaining four of the first five orders receive $11 M each ($44/4). There is no remaining liquidity for subsequent orders.

Example 4: if one of the first five buy orders is for $50 MM and the remaining four are for $1 MM each, the four $1 MM orders are filled first, and the $50 MM order receives $46 MM. There is no remaining available liquidity for subsequent orders.

The trading platform may provide a number of graphical user interfaces for order entry and order fulfillment reporting. FIGS. 4A-E are graphical user interface diagrams for order entry and processing. Order entry panel 402 may display security details 404, sell or ask 410 and buy or bid 412. The mid-market, with the spread from the mid at which buy or sell orders can be entered may also be clearly displayed to clients. The order entry panel may further include an area 406 for entering the quantity of securities for buy or sell, radio buttons for selecting order fulfillment methods such as partial fill 414 and fill or kill 416. The user interface may also specify a minimum order requirement, and in some implementations, minimum increment 418 for the quantity of order may also be displayed. When, for example, the sell side is selected, order entry panel 420 of FIG. 4B may be displayed. Once the quantity of a financial instrument is input at 422, the sell (or buy) side 424 of the trade is selected, the order may be submitted by selecting the sell button 426. Upon submission of the order, order entry panel 430 of FIG. 4C may be displayed. Order entry panel 430 may include order details 432, a cancel button 434 to cancel the order, and a status bar 436 to indicate the amount of time remaining for cancellation.

Referring to FIG. 4D, if the order is not cancelled during the cancellation period, an order processing panel 440 may be displayed. The panel 440 may include a status bar 442 that indicates the time remaining for completing the processing. Referring to FIG. 4E, an order summary panel 450 may be displayed when the order processing is completed. The order summary panel 450 may include an indication 452 for successful (or unsuccessful) processing of the order. For example, the indication 452 may provide information regarding complete fill, partial fill or no fill of the orders.

FIG. 4F is a graphical user interface diagram illustrating an order fulfillment report 460 provided to clients after trade executions. The report may include a recap of the trade, including executions and non-executions. For example, the report may include information such as, but not limited to: security details, an execution date, a notional amount, a side, a security identifier such as CUSIP, price/spread, settlement data, a trader or client name, and/or the like.

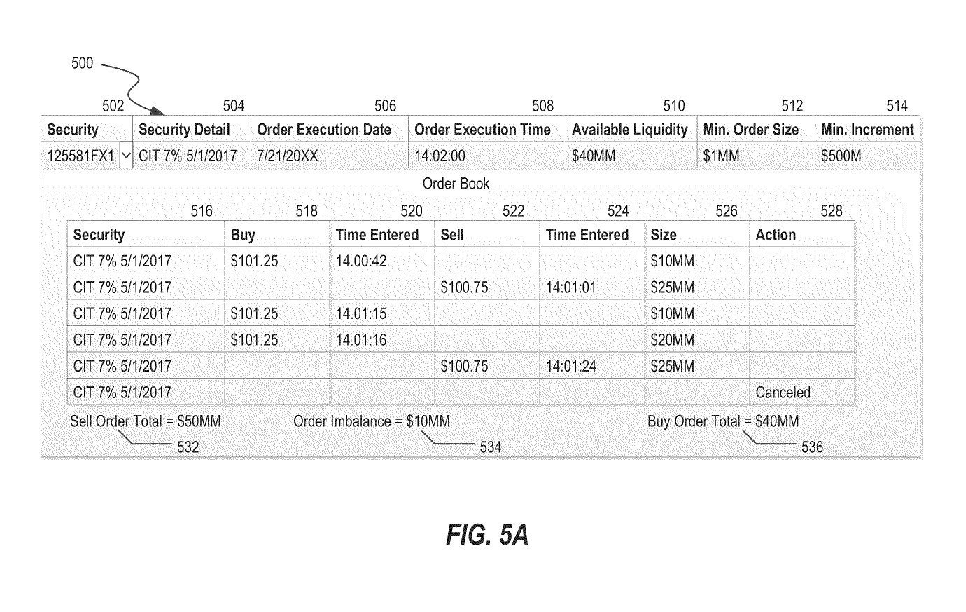

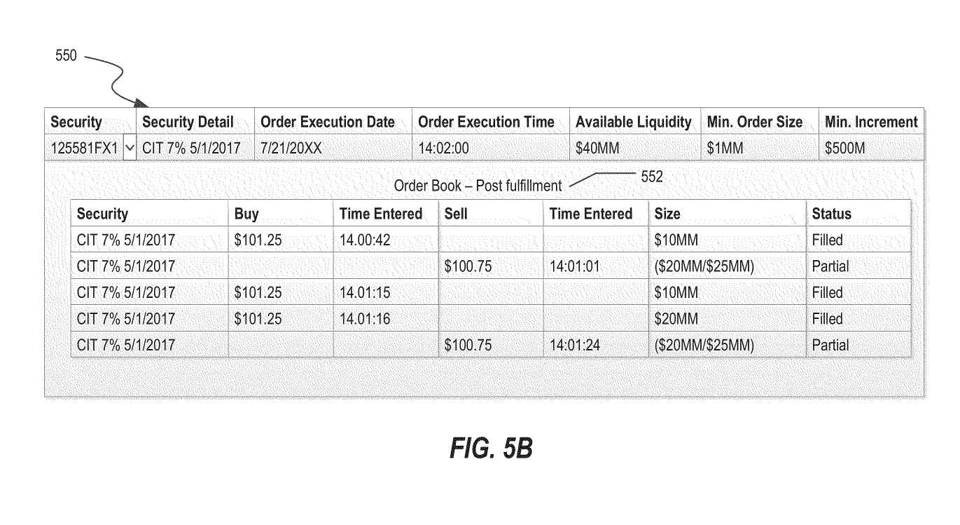

FIGS. 5A-B are user interface diagrams illustrating order books before and after order fulfillment. Referring to FIG. 5A, order book 500 may include order parameter data such as, but not limited to: security identifier 502, security detail 504, order execution date 506, order execution time 508, available liquidity 510, minimum order size 512 and minimum increment size 514. The order book may also include an entry for each received order. For example, each order entry may identify the financial instrument (e.g., security) 516, buy price at 518 if the order is a buy order, time the buy order was entered 520, sell price if the order is a sell order, time the sell order was entered 524, size of the order 526, and any action 528 taken. In one implementation, a client is allowed to take an action such as a cancellation action to cancel the order. The order book may also display the total sell order 532, total buy order 536 and the order imbalance 534. After execution of the orders by the order fulfillment engine, the order book of FIG. 5A may be updated to display the order book of FIG. 5B. The order book 550 may also display the order parameters. Additionally, the status column may be updated for each order. For example, the first, third and fourth orders have filled status, while the second and fifth orders have partial fill status.

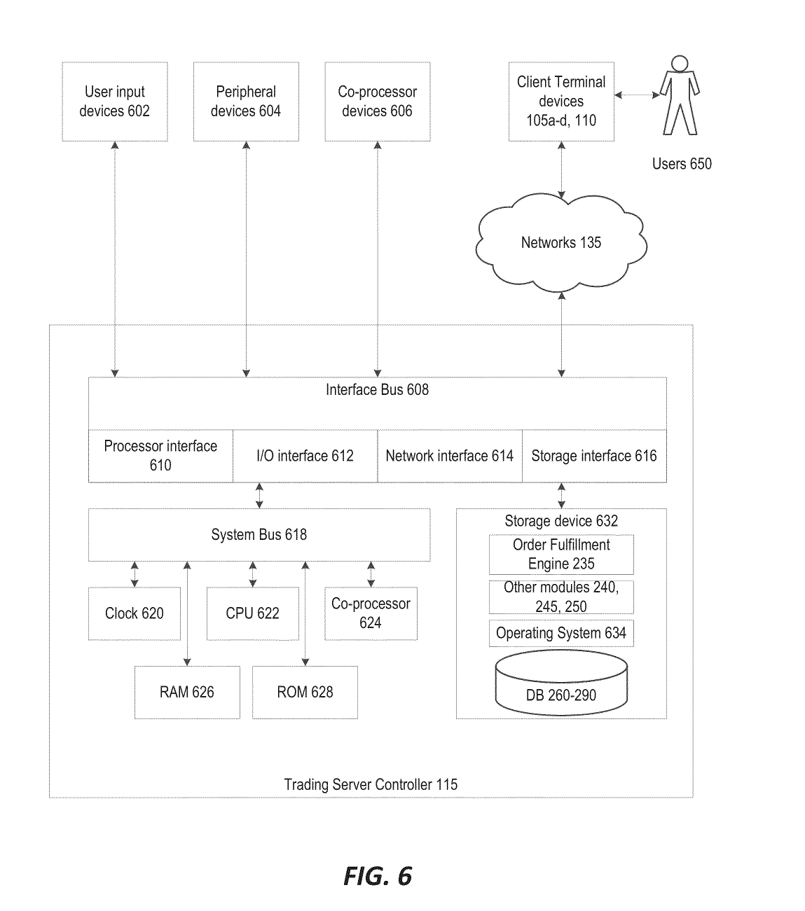

Aspects and implementations of the order fulfillment method and the trading system or order fulfillment system implementing the order fulfillment method have been described in the general context of computer-executable instructions, such as routines executed by a general-purpose computer, a personal computer, a server, and/or other computing systems. The trading system may be embodied in a special purpose computer or data processor that is specifically programmed, configured, or constructed to perform one or more of the computer-executable instructions explained in detail above. Indeed, the terms “computer” and “computing device,” as used generally herein, refer to devices that have a processor and non-transitory memory, as well as any data processor or any device capable of communicating with a network. Referring to FIG. 6, a block diagram of the trading server controller 600 is illustrated. The trading server controller 115 may be in communication with entities including one or more users 650, client terminal devices 105a-d, user input devices 602, peripheral devices 604, an optional co-processor device(s) (e.g., cryptographic processor devices) 606, and networks 135. Users 650 such as clients, traders and others may engage with the trading server controller 115 via the trading platform accessible from their client terminal devices 105a-d, 110.

Computers employ central processing unit (CPU) or processor (hereinafter “processor”) to process information. Processors may include programmable general-purpose or special-purpose microprocessors, programmable controllers, application-specific integrated circuits (ASICs), programmable logic devices (PLDs), embedded components, combination of such devices and the like. Processors execute program components or modules in response to user and/or system-generated requests. One or more of these components or modules may be implemented in software, hardware or both hardware and software. Processors pass instructions (e.g., operational and data instructions) to enable various operations. The trading server controller may include clock 620, CPU 622, memory such as read only memory (ROM) 628 and random access memory (RAM) 626 and co-processor 624 among others. These controller components may be connected to a system bus 618, and through the system bus 618 to an interface bus 608. Further, user input devices 602, peripheral devices 604, co-processor devices 606, and the like, may be connected through the interface bus 608 to the system bus 618. The Interface bus 608 may be connected to a number of interface adapters such as processor interface 610, input output interfaces (I/O) 612, network interfaces 614, storage interfaces 616, and the like.

Processor interface 610 may facilitate communication between co-processor devices 606 and co-processor 624. In one implementation, processor interface 610 may expedite encryption and decryption of requests or data. Input Output interfaces (I/O) 612 facilitate communication between user input devices 602, peripheral devices 604, co-processor devices 606, and/or the like and components of the trading server controller using protocols such as those for handling audio, data, video interface, wireless transceivers, or the like (e.g., Bluetooth, IEEE 1394a-b, serial, universal serial bus (USB), Digital Visual Interface (DVI), 802.11a/b/g/n/x, cellular, etc.). Network interfaces 614 may be in communication with networks 135. Through networks 135, the trading server controller may be accessible to the remote client devices. Network interfaces 614 may use various wired and wireless connection protocols such as, direct connect, Ethernet, wireless connection such as IEEE 802.11a-x, and the like. Examples of networks 135 include the Internet, Local Area Network (LAN), Metropolitan Area Network (MAN), a Wide Area Network (WAN), wireless network (e.g., using Wireless Application Protocol WAP), a secured custom connection, and the like. Storage interfaces 616 may be in communication with a number of storage devices such as, storage devices 632, removable disc devices, and the like. The storage interfaces 616 may use various connection protocols such as Serial Advanced Technology Attachment (SATA), IEEE 1394, Ethernet, Universal Serial Bus (USB), and the like.

User input devices 602 and peripheral devices 604 may be connected to I/O interface 612 and potentially other interfaces, buses and/or components. User input devices 602 may include card readers, finger print readers, joysticks, keyboards, microphones, mouse, remote controls, retina readers, touch screens, sensors, and/or the like. Peripheral devices 604 may include antenna, audio devices (e.g., microphone, speakers, etc.), cameras, external processors, communication devices, radio frequency identifiers (RFIDs), scanners, printers, storage devices, transceivers, and/or the like. Co-processor devices 606 may be connected to the trading server controller through interface bus 608, and may include microcontrollers, processors, interfaces or other devices.

Computer executable instructions and data may be stored in memory (e.g., registers, cache memory, random access memory, flash, etc.) which is accessible by processors. These stored instruction codes (e.g., programs) may engage the processor components, motherboard and/or other system components to perform desired operations. The trading server controller may employ various forms of memory including on-chip CPU memory (e.g., registers), RAM 626, ROM 628, and storage devices 632. Storage devices 632 may employ any number of tangible, non-transitory storage devices or systems such as fixed or removable magnetic disk drive, an optical drive, solid state memory devices and other processor-readable storage media. Computer-executable instructions stored in the memory may include one or more program modules such as routines, programs, objects, components, data structures, and so on that perform particular tasks or implement particular abstract data types. For example, the memory may contain operating system (OS) component 634, user interface and other modules 235-250, database tables 260-290, and the like. These components may be stored and accessed from the storage devices, including from external storage devices accessible through an interface bus. The database components 260-290 may store programs executed by the processor to process the stored data. The database components may be implemented in the form of a database that is relational, scalable and secure. Examples of such database include DB2, MySQL, Oracle, Sybase, and the like. Alternatively, the database may be implemented using various standard data-structures, such as an array, hash, list, struct, structured text file (e.g., XML), table, and/or the like. Such data-structures may be stored in memory and/or in structured files.

In some implementations, the trading server controller may be implemented in distributed computing environments, where tasks or modules are performed by remote processing devices, which are linked through a communications network, such as a Local Area Network (“LAN”), Wide Area Network (“WAN”), the Internet, and the like. In a distributed computing environment, program modules or subroutines may be located in both local and remote memory storage devices. Distributed computing may be employed to load balance and/or aggregate resources for processing. Alternatively, aspects of the order fulfillment engine may be distributed electronically over the Internet or over other networks (including wireless networks). Those skilled in the relevant art will recognize that portions of the order fulfillment engine may reside on a server computer, while corresponding portions reside on a client computer. Data structures and transmission of data particular to aspects of the order fulfillment engine are also encompassed within the scope of the invention.

The above Detailed Description of embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times.

In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

We claim:

1. A processor-implemented order execution method, comprising:
receiving a plurality of orders to trade a financial instrument, each order specifying an order size and a trade side;
identifying, by a processor, a trade side with aggregate order size larger than that of an opposing trade side;
determining, by the processor, a priority for executing orders on the identified trade side based on available liquidity and time of order entry; and
executing, by the processor, one or more orders on the identified trade side according to the determined priority.

2. The method of claim 1, wherein determining the priority for executing orders further comprises:
selecting, based on time of order entry, a specified number of orders as having the first priority for execution.

3. The method of claim 2, wherein the available liquidity equals or exceeds aggregate order size of the selected orders, and the executing further comprises:
using the available liquidity to fill the selected orders on the identified trade side.

4. The method of claim 3, wherein the available liquidity exceeds the aggregate order size of the selected orders by an excess liquidity amount and the priority for executing orders remaining on the identified trade side is determined based on allocation of the excess liquidity amount according to time of order entry.

5. The method of claim 2, wherein when aggregate order size of the selected orders exceeds the available liquidity, determining the priority for executing orders further comprises:
determining an executable order size for each of the selected orders by allocating the available liquidity equally to the selected orders.

6. The method of claim 5, wherein the executing further comprises:
using the available liquidity to fill the executable order size of each of the selected orders.

7. The method of claim 5, wherein when order size of at least one of the selected orders is smaller than the allocated liquidity, determining the priority for executing orders further comprises:
determining an executable order size for the at least one of the selected orders by reallocating the available liquidity equivalent to the order size to the at least one of the selected orders;
determining an executable order size for each of remaining selected orders by reallocating remainder of the available liquidity equally to each of the remaining selected orders.

8. The method of claim 7, wherein the executing further comprises:
using the available liquidity to fill the executable order size of each of the selected orders.

9. The method of claim 1, further comprising:
generating a report providing information on execution status of each of the plurality of orders, wherein the execution status is at least one of filled, partially filled and unfilled.

10. The method of claim 1, wherein the available liquidity is aggregate order size that is available for cross trade.

11. The method of claim 1, wherein the available liquidity is a notional amount of liquidity made available for execution.

12. The method of claim 11, wherein the available liquidity includes one or more of:
liquidity provided by a dealer, additional liquidity injected by a trader on behalf of the dealer and contra liquidity.

13. The method of claim 1, wherein the financial instrument includes at least one of a debt instrument, an over the counter derivative product and an equity instrument.

14. An order trading platform, comprising:
a user interface module including processor-executable instructions configured to receive a plurality of orders to trade a financial instrument, each order specifying an order size and a trade side;
an order fulfillment engine having a memory, and processor disposed in communication with the memory, the order fulfillment engine configured to:
identify a trade side with aggregate order size larger than that of an opposing trade side;
determine a priority for executing orders on the identified trade side based on available liquidity and time of order entry; and
execute one or more orders on the identified trade side according to the determined priority.

15. The trading platform of claim 14, further comprising:
a reporting module including processor-executable instructions configured to generate a report providing information on execution status of each of the plurality of orders, wherein the execution status is at least one of filled, partially filled and unfilled.

16. The trading platform of claim 14, wherein the financial instrument includes one of a debt instrument, an over the counter derivative product and an equity instrument, and the plurality of orders are block orders.

17. The trading platform of claim 14, wherein the order fulfillment engine is further configured to:
select, based on time of order entry, a specified number of orders as having the first priority for execution.

18. The trading platform of claim 17, wherein the available liquidity equals or exceeds an aggregate order size of the selected orders, and the order fulfillment engine is further configured to:
fill the selected orders on the identified trade side using the available liquidity.

19. The trading platform of claim 18, wherein the available liquidity exceeds aggregate order size of the selected orders by an excess liquidity amount, and the priority for executing orders remaining on the identified trade side is determined based on allocation of the excess liquidity amount according to time of order entry.

20. The trading platform of claim 17, wherein when aggregate order size of the selected orders exceeds the available liquidity, the order fulfillment engine is further configured to:
determine an executable order size for each of the selected orders by allocating the available liquidity equally to the selected orders.

21. The trading platform of claim 20, wherein the order fulfillment engine is further configured to:
use the available liquidity to fill the executable order size of each of the selected orders.

22. The trading platform of claim 20, wherein when order size of at least one of the selected orders is smaller than the allocated liquidity, the order fulfillment engine is further configured to:
determine an executable order size for the at least one of the selected orders by reallocating the available liquidity equivalent to the order size to the at least one of the selected orders;
determine an executable order size for each of remaining selected orders by reallocating remainder of the available liquidity equally to each of the remaining selected orders.

23. The trading platform of claim 22, wherein the order fulfillment engine is further configured to:
use the available liquidity to fill the executable order size of each of the selected orders.

24. The trading platform of claim 14, wherein the available liquidity is a notional amount of liquidity made available for execution.

25. The trading platform of claim 24, wherein the available liquidity includes one or more of: liquidity provided by a dealer, additional liquidity injected by a trader on behalf of the dealer and contra liquidity.

26. A processor-readable non-transient medium storing instructions to:
receive a plurality of orders to trade a financial instrument, each order specifying an order size and a trade side;
identify a trade side with aggregate order size larger than that of an opposing trade side;
determine a priority for executing orders on the identified trade side based on available liquidity and time of order entry; and
execute one or more orders on the identified trade side according to the determined priority.

27. The medium of claim 26, further comprising instructions to:
generate a report providing information on execution status of each of the plurality of orders, wherein the execution status is at least one of filled, partially filled and unfilled.

28. The medium of claim 26, wherein the financial instrument is at least one of a debt instrument, an over the counter derivative product and an equity instrument, and the plurality of orders are block orders.

29. The medium of claim 26, further comprising instructions to:
select, based on time of order entry, a specified number of orders as having the first priority for execution.

30. The medium of claim 29, wherein the available liquidity equals or exceeds an aggregate order size of the selected orders, further comprising instructions to:
fill the selected orders on the identified trade side using the available liquidity.

31. The medium of claim 30, wherein the available liquidity exceeds aggregate order size of the selected orders by an excess liquidity amount and the priority for executing orders remaining on the identified trade side is determined based on allocation of the excess liquidity amount according to time of order entry.

32. The medium of claim 29, wherein when aggregate order size of the selected orders exceeds the available liquidity, further comprising instructions to:
determine an executable order size for each of the selected orders by allocating the available liquidity equally to the selected orders.

33. The medium of claim 32, further comprising instructions to:
use the available liquidity to fill the executable order size of each of the selected orders.

34. The medium of claim 32, wherein when order size of at least one of the selected orders is smaller than the allocated liquidity, further comprising instructions to:
determine an executable order size for the at least one of the selected orders by reallocating the available liquidity equivalent to the order size to the at least one of the selected orders;
determine an executable order size for each of remaining selected orders by reallocating remainder of the available liquidity equally to each of the remaining selected orders.

35. The medium of claim 34, further comprising instructions to:
use the available liquidity to fill the executable order size of each of the selected orders.

36. The medium of claim 26, wherein the available liquidity is a notional amount of liquidity made available for execution.

37. The medium of claim 36, wherein the available liquidity includes one or more of: liquidity provided by a dealer, additional liquidity injected by a trader on behalf of the dealer and contra liquidity.

38. A block order execution method, performed by a computing system having a processor and a memory, the method comprising:
receiving a plurality of block orders, each block order specifying an order size and a trade side;
obtaining order execution rules;
identifying an imbalanced trade side;
determining, using the order execution rules, one or more block orders for execution; and
executing each of the one or more block orders against liquidity allocated according to the order execution rules.

39. The method of claim 38, the determining further comprises:
selecting, in order of time priority, a predefined number of block orders from the imbalanced side for execution.

40. The method of claim 39, further comprising:
allocating available liquidity equally to each of the selected block orders.

41. The method of claim 40, further comprising:
identifying, from the selected block orders, a block order having a block order size smaller than the allocated liquidity;
deallocating the allocated liquidity from each of the selected block orders;
allocating to the block trade, liquidity that is equivalent to the corresponding block trade size;
determining liquidity remaining after the allocating;
allocating the remaining liquidity equally to each of remaining selected block orders.

42. The method of claim 40, further comprising:
determining liquidity remaining after the allocating;
selecting from the imbalanced side a block order next in order of time priority; and
allocating the remaining liquidity to the selected block order.
